(19) United States
(12) Patent Application Publication
(10) Pub. No.: US 2016/0312844 A1
(43) Pub. Date: Oct. 27, 2016

(54) BRAKE DISC STRUCTURE

(71) Applicant: CHUEN-FENG TSENG, Puzi City (TW)

(72) Inventor: CHUEN-FENG TSENG, Puzi City (TW)

(21) Appl. No.: 14/693,375

(22) Filed: Apr. 22, 2015

(51) Int. Cl. F16D 65/12

(52) U.S. Cl. CPC F16D 65/128; F16D 65/123; F16D 2065/132

(57) ABSTRACT

A brake disc structure contains: a base, an inner disc, an intermediate disc, and an outer disc. The base includes a plurality of first holes, the inner disc includes plural second holes, the intermediate disc includes a plurality of third holes, and the outer disc includes plural fourth holes arranged proximate to an inner peripheral side thereof, such that a plurality of screws are inserted through the plurality of first holes, the plural second holes, the plurality of third holes, and the plurality of fourth holes to screw the base, the inner disc, the intermediate disc, and the outer disc together. The intermediate disc also includes a plurality of ribs separately arranged on two surfaces thereof, and between any two ribs is defined an air passage, plural retaining slots are formed around an outer peripheral side of the intermediate disc and are connected with a plurality of coupling bolts.

### FIELD OF THE INVENTION

The present invention relates to a brake disc structure which dissipates heat quickly and reduces its production cost greatly.

### BACKGROUND OF THE INVENTION

Referring to FIGS. 1 and 2, a conventional brake disc structure 10 contains an inner disc 11, an outer disc 12, and a base 13, wherein between the inner disc 11 and the outer disc 12 are separately arranged a plurality of ribs 14, and between any two ribs 14 is defined an air passages 15 to flow air.

However, such a conventional brake disc structure has following defects:

1. An area of each rib 14 is smaller than that of the present invention, thus removing heat inefficiently.

2. The base 13, the inner disc 11, the outer disc 12, and plurality of ribs 14 are integrally metal casted to cause high manufacture cost.

3. As one of the base 13, the inner disc 11, and the outer disc 12 is broken, the base 13, the inner disc 11, and the outer disc 12 are replaced together, because they are integrally metal casted, thus having high replacement cost.

The present invention has arisen to mitigate and/or obviate the afore-described disadvantages.

### SUMMARY OF THE INVENTION

The primary objective of the present invention is to provide a brake disc structure in which a base, an inner disc, an intermediate disc, and an outer disc are produced individually, and then they are connected together to simplify manufacture process and reduce production cost greatly.

Another objective of the present invention is to provide a brake disc structure which saves replacement cost, dissipates heat quickly and reduces its weight.

To obtain above objectives, a brake disc structure provided by the present invention contain: a base, an inner disc, an intermediate disc, and an outer disc.

The base includes a plurality of first holes, the inner disc includes plural second holes, the intermediate disc includes a plurality of third holes, and the outer disc includes plural fourth holes arranged proximate to an inner peripheral side thereof, such that a plurality of screws are inserted through the plurality of first holes, the plural second holes, the plurality of third holes, and the plurality of fourth holes to screw the base, the inner disc, the intermediate disc, and the outer disc together.

The intermediate disc also includes a plurality of ribs separately arranged on two surfaces thereof, and between any two ribs is defined an air passage, plural retaining slots are formed around an outer peripheral side of the intermediate disc and are connected with a plurality of coupling bolts.

### BRIEF DESCRIPTION OF THE DRAWINGS

FIG. 1 is a perspective view showing the assembly of a conventional brake disc structure.

FIG. 2 is a perspective view showing the exploded components of the conventional brake disc structure.

FIG. 3 is a perspective view showing the exploded components of a brake disc structure according to a preferred embodiment of the present invention.

FIG. 4 is a perspective view showing the assembly of the brake disc structure according to the preferred embodiment of the present invention.

FIG. 5 is a cross sectional view showing the assembly of the brake disc structure according to the preferred embodiment of the present invention.

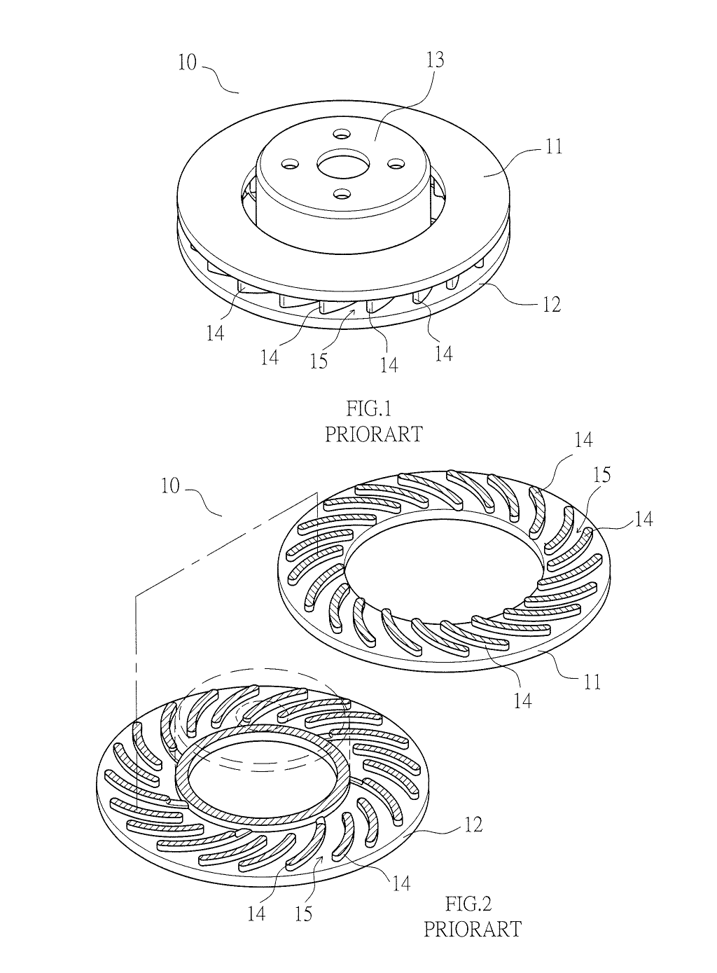

### DETAILED DESCRIPTION OF THE PREFERRED EMBODIMENTS

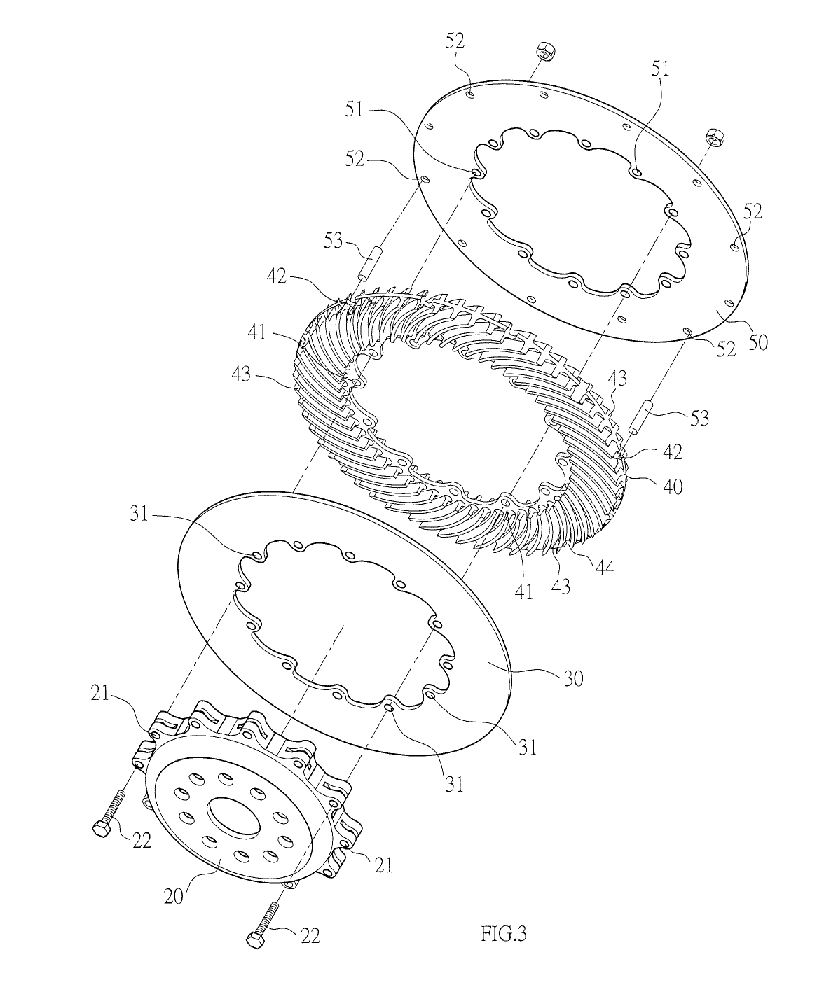

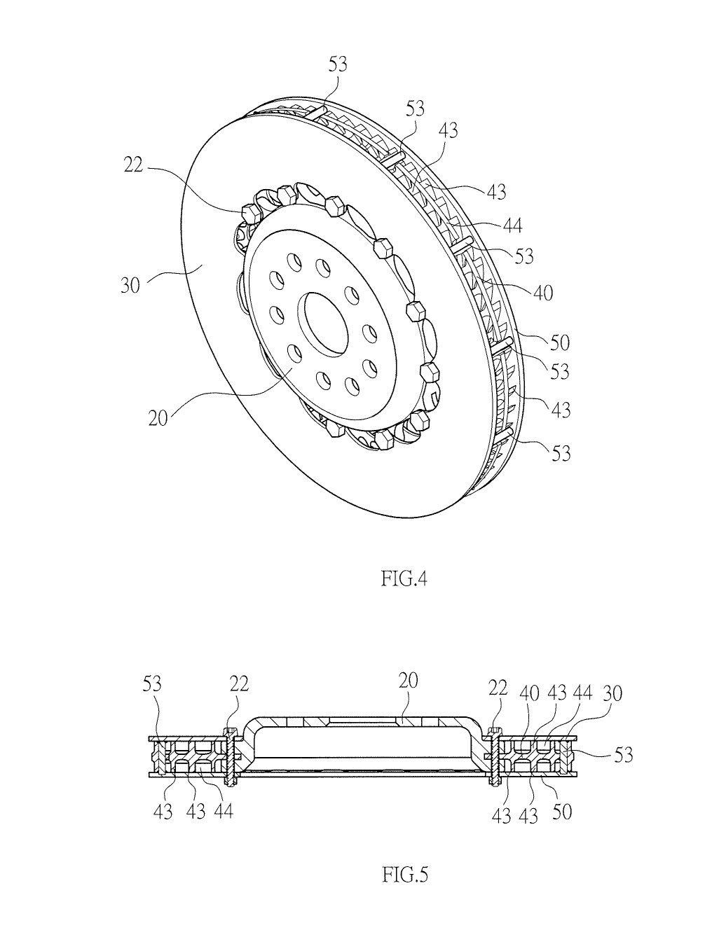

With reference to FIGS. 3 to 5, a brake disc structure according to a preferred embodiment of the present invention comprises: a base 20, an inner disc 30, an intermediate disc 40, and an outer disc 50. The base 20 includes a plurality of first holes 21, the inner disc 30 includes plural second holes 31, the intermediate disc 40 includes a plurality of third holes 41, and the outer disc 50 includes plural fourth holes 51 arranged proximate to an inner peripheral side thereof, such that a plurality of screws are inserted through the plurality of first holes 21, the plural second holes 31, the plurality of third holes 41, and the plurality of fourth holes 51 to screw the base 20, the inner disc 30, the intermediate disc 40, and the outer disc 50 together. The intermediate disc 40 is made of aluminum alloy and also includes a plurality of ribs 43 separately arranged on two surfaces thereof, wherein between any two ribs 43 is defined an air passage 44, and plural retaining slots 42 are formed around an outer peripheral side of the intermediate disc 40 and are in connection with a plurality of coupling bolts 53; each of the outer disc 50 and the inner disc 30 also includes a plurality of locking notches 52 for corresponding to the plural retaining slots 42 of the intermediate disc 40, such that the plurality of coupling bolts 53 are inserted through the plurality of locking notches 52 of the outer disc 50 and the plural retaining slots 42 of the intermediate disc 40 to couple with the plurality of locking notches 52 of the inner disc 30, thus connecting the inner disc 30, the intermediate disc 40, and the outer disc 50 together.

Thereby, the brake disc structure of the present invention has advantages as follows:

1. The base 20, the inner disc 30, the intermediate disc 30, and the outer disc 50 are produced individually, and then they are connected together to simplify manufacture process and to reduce production cost.

2. Due to the base 20, the inner disc 30, the intermediate disc 40, and the outer disc 50 are produced individually, and then e they are connected tighter, when thinner disc 30 or the outer disc 50 is broken, it is replaced independently, thus saving replacement cost.

3. The intermediate disc 40 includes the plurality of ribs 43 and the plural air passages 44 to dissipate heat quickly.

4. The intermediate disc 40 is made of the aluminum alloy to reduce weight and to dissipate heat rapidly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A brake disc structure comprising:
a base, an inner disc, an intermediate disc, and an outer disc;
wherein the base includes a plurality of first holes, the inner disc includes plural second holes, the intermediate disc includes a plurality of third holes, and the outer disc includes plural fourth holes arranged proximate to an inner peripheral side thereof, such that a plurality of screws are inserted through the plurality of first holes, the plural second holes, the plurality of third holes, and the plurality of fourth holes to screw the base, the inner disc, the intermediate disc, and the outer disc together;
wherein the intermediate disc also includes a plurality of ribs separately arranged on two surfaces thereof, and between any two ribs is defined an air passage.

2. The brake disc structure as claimed in claim 1, wherein the intermediate disc further includes plural retaining slots formed around an outer peripheral side of the intermediate disc and connected with a plurality of coupling bolts, and each of the outer disc and the inner disc also includes a plurality of locking notches for corresponding to the plural retaining slots of the intermediate disc, such that the plurality of coupling bolts are inserted through the plurality of locking notches of the outer disc and the plural retaining slots of the intermediate disc to couple with the plurality of locking notches of the inner disc.
